(19) United States
(12) Patent Application Publication
(10) Pub. No.: US 2006/0271388 A1
(43) Pub. Date: Nov. 30, 2006

(54) Derivative securities utilizing commercial real estate indices as underlying

(76) Inventor: Patrick P. Lecomte, Nevers (FR)

Correspondence Address: Mr. Patrick P. Lecomte, 22 rue Paul Vaillant Couturier, Nevers, 58000, FR

(21) Appl. No.: 11/269,645

(22) Filed: Nov. 9, 2005

Related U.S. Application Data
(63) Continuation of application No. 60/685,405, filed on May 31, 2005.

(51) Int. Cl. G06Q 99/00

(52) U.S. Cl. 705/1

(57) ABSTRACT

Standardized derivatives markets cover a wide array of risks including energy, credit, and weather. However, one major asset class is conspicuously missing from this list: commercial real estate. Indeed, commercial property markets are the last of the major institutional asset classes not to have liquid futures and options markets. Thanks to their innovative combination of specifications, our real estate futures and options contracts stick to the fundamental characteristics of real estate as a slow, illiquid and heterogeneous asset class. They allow standardization and transacting of property derivatives on organized exchanges and thus represent an important breakthrough in the process of ‘commodization’ of unsecuritized commercial real estate assets.

### CROSS REFERENCE TO RELATED APPLICATION

This nonprovisional application for patent is claiming the benefit of the provisional application No. 60/685,405 filed on May, 31, 2005.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

The specification contains two appendices attached with this document (pages 13 and 14). Each appendix is one page long. Appendix 1 contains three tables numbered from 1 to 3 presenting the 75 index codes by type of return. Appendix 2 contains one table presenting the futures contracts' main specifications.

### BACKGROUND OF THE INVENTION

Standardized derivatives markets cover a wide array of risks including energy, credit, and weather. However, one major asset class is conspicuously missing from this list: commercial real estate. Indeed, commercial property markets are the last of the major institutional asset classes not to have liquid futures and options markets. Despite intense interest from the academic community for futures and options cash-settled on real estate prices, participants in US commercial real estate markets still have no efficient and cost-effective ways to hedge their exposure to risks.

References include:

Black, D. G. (1986) “Success and Failure of Futures Contracts: Theory and Empirical Evidence.” Monograph Series in Finance and Economics 1986-1, New York University, Salomon Brothers Center for the Study of Financial Institutions.

Case K. E., Shiller R. J., Weiss A. N. (1992) “Index-Based Futures and Options Markets in Real Estate”, Yale University, Cowles Foundation Discussion Paper 1006 (http://cowles.econ.yale.edu/P/cd/d10a/d1006.pdf)

Corkish J., Holland A., and Fremault Vila, A. (1997) “The Determinants of Successful Financial Innovation: An Empirical Analysis of Futures Innovation on LIFFE”, Bank of England, Working Paper Series.

Ederington L. H. (1979) “The Hedging Performance of the New Futures Markets”, The Journal of Finance, Vol. 34, No. 1, 157-170.

Figlewski S. (1984) “Hedging Performance and Basis Risk in Stock Index Futures”, The Journal of Finance, Vol. 39, No. 3, 657-669.

Fisher J. “Introducing the NPI Based Derivative. New Strategies for Real Estate Investment and Risk Management”, NCREIF Quarterly Highlight, First Quarter 2005 (www.ncreif.com).

Fisher J., Geltner D., and R. Webb (1994) “Value Indices of Commercial Real Estate: A Comparison of Index Construction Methods” The Journal of Real Estate Finance and Economics, Vol. 9.

Fisher, J. and M. Young (2000) “Holding Periods for Institutional Real Estate in the NCREIF Database”, Real Estate Finance, Vol. 17 Issue. 3.

Geltner D. (1998) “How accurate is the NCREIF Index as a Benchmark, and who cares?” Real Estate Finance, Vol. 14 Issue 4.

Geltner D., and N. Miller (2001) “Commercial Real Estate Analysis and Investments”, South Western Publishing.

Gordon J. N. and Hasvy J. R. (1999) “Derivatives Markets: How far does real estate have to go?” Real Estate Finance, Vol. 16, Issue. 2, 39-49.

Hull J. C., (2003) “Options, Futures and Other Derivatives”, Prentice Hall, Fifth Edition.

Lecomte P. and McIntosh W. (2005) “Is This a Revolution? Property Derivatives could change the Real Estate Markets” The Institutional Real Estate Letter, Vol. 18 No. 10, October (www.irei.com)

Lecomte P. and McIntosh W. (2005) “Going Synthetic: The Next Frontier for Property Derivatives” The Institutional Real Estate Letter, Vol. 18 No. 11, November (www.irei.com)

### BRIEF SUMMARY OF THE INVENTION

This specification presents the design of index-based property futures and property options contracts based on NCREIF Property Indices. NCREIF is an acronym for the National Council of Real Estate Investment Fiduciaries. The National Council of Real Estate Investment Fiduciaries is an association of institutional real estate professionals. Produced quarterly, the NCREIF Property Indices (NPIs) show real estate performance returns using data submitted to NCREIF by its Data Contributing Members. Hence, NPIs are indices on private US real estate assets. NPIs are used as industry benchmarks to compare an investor's own returns against the industry averages. The NPI-based derivative securities presented thereafter are relevant to the US commercial real estate market. They are meant to be listed on organized exchanges. Potential market for these derivative securities is very large and includes participants in the real estate industry, fund managers, hedge fund managers, pension funds, and more generally any parties involved in investment management and risk management.

Financial instruments described in this specification enable investors to hedge risks involved in US commercial real estate assets in an efficient, cost effective manner. Likewise, they foster diversification of real estate portfolios and financial asset portfolios alike.

### BRIEF DESCRIPTION OF THE SEVERAL VIEWS OF THE DRAWING

Not Applicable.

### DETAILED DESCRIPTION OF THE INVENTION

Paragraphs numbered [009] to [017] of the specification presents the general structure and the mechanics of the futures contracts as well as their main four specifications:
Structure of the contracts (paragraph [010]),
Mechanics of the contracts (paragraph [011]),
Choice of underlying indices (paragraphs [012] to [014]),
Contract months and time horizon (paragraph [015]),
Contract size (paragraph [016]),
Settlement procedures (paragraph [017]).

General Structure of the contracts: our property futures are based on a contract for difference, which allows counter parties to take opposite positions on the performance of the underlying NCREIF Property Indices (NPI) over a specific timeframe. The futures contracts are based on the indices published quarterly and yearly by NCREIF. Yearly indices are based on calendar year performances (from January to December).

The mechanics of the contract implies that the delivery of the face value of the contract never occurs. Contracts are cash-settled upon expiration. Long and short positions are simply marked to a final settlement price, based on the index return. Concretely, the index return is equal to (EI-BI)/BI where BI and EI are respectively the index beginning and ending values. The Index Amount for one contract is given by: Notional amount for a contract×Index Return. If the Index Amount for an expiry date is positive, a sum in USD equal to such amount will be payable by the property futures seller to the property futures buyer. If the Index Amount is negative, its absolute value will be payable by the property futures buyer to the property futures seller on settlement date. The value of the NPI was set at 100 at Q4, 1977. Index Return will be based on revised NPI values.

Key concepts for the choice of underlying indices: Real estate risk is very localized. Unique risk is therefore a major part of real estate total risk. By definition, index-based futures can only address systematic risk. Thus, in order to offer effective hedging, NPI-based futures will have to modify the structure of real estate risk, by increasing the scope of systematic risk in the total risk components of the hedged properties. The amount of total risk we cover will become larger as our contracts' characteristics get closer to those of the hedged properties.

Three levels of analysis: The NCREIF database is constructed in such a way that it gives immediate access to three levels of analysis according to both property type classification and geographic division. In addition to the classic national index, the NPI covers five property types (Apartment, Industrial, Office, Retail, Hotel) and four main regions (East, South, Midwest, West). Although there are also eight sub regions (Northeast, Mideast, Southeast, East North Central, South West, West North Central, Mountain, Pacific), we only consider the four main regions in the analysis presented thereafter. Our analysis can be easily extended to the eight sub regions if necessary. The three levels of analysis are:
Level 1: National (1 generic index),
Level 2: Property Type OR Region (respectively 5 generic indices and 4 generic indices),
Level 3: Property Type AND Region (20 generic indices).
   These three levels of analysis are available for three different types of return used in the establishment of NPIs:
Total Return,
Income Return,
Capital Appreciation Return.

In the table below, we exclude hotel properties which are not covered in our analysis for lack of sufficient data as of October 2005. They will have to be included when more data become available. Excluding hotel properties, there are 75 indices readily available to serve as underlying to futures contracts. Property futures contracts can trade on any of these 75 underlying indices.

| | # | |
|---|---|---|
| | indexes | Explanation |
| LEVEL 1: National NPI | 3 | 3 types of return |
| LEVEL 2: Property | 12 | 4 property types × |
| Type NPI | | 3 types of return |
| LEVEL 2: Regional NPI | 12 | 4 regions × 3 types of return |
| LEVEL 3: Property | 48 | 4 prop types × |
| Type × Region NPI | | 4 regions × 3 types of return |
| | 75 | including Hotel, Total = 90 |

We attribute a different index code to each of these 75 indices based on a simple acronym system: two letters for a level 1 or level 2 index, three letters for a level 3 index (e.g. TN=Total return National, IOE=Income return for Office properties in the Eastern region, CAM=Capital appreciation return for Apartment properties in the Midwest). This system can be generalized to any number of levels for all real estate indices. Appendix 1 presents three tables in which the 75 index codes are organized by type of return.

Methodologies for selecting underlying indices to property futures: We apply the following two methodologies described in (i) and (ii) below to determine which indices are to be used as underlying to property futures and what criteria (geographic division, property type, type of return) are the most important in selecting underlying indices to property futures. We apply the same methodologies for selecting underlying to property options (paragraphs [018] to [020] of this specification).

(i) The method of corresponding correlations: For all potential indices, we look at mean return, standard deviation, and correlations. Correlation analysis is conducted according to the following methodology: for each Level i index (i=2,3), we compute correlations with corresponding Level i−1 indices and if applicable with corresponding Level i−2 indices. We call this process the ‘method of corresponding correlations analysis’.

Concretely,

LEVEL 1 (National NPIs): no correlation analysis
LEVEL 2 (Regional NPIs): correlation coefficient between each ‘Region×Type of Return’ NPI and corresponding ‘National×Type of Return’ NPI (LEVEL 1), e.g. Total Return Midwest and Total Return National or r(TM, TN)
LEVEL 2 (Property Type NPIs): correlation coefficient between each ‘Property Type×Type of Return’ NPI and corresponding ‘National×Type of Return’ NPI (LEVEL 1), e.g. Income Return Retail and Income Return National or r(IR, IN)
LEVEL 3 (Property Type×Region NPIs): for each index (‘Property Type×Region×Type of Return’ NPI), we compute 3 correlations as follows:
   Correlation with corresponding ‘National×Type of Return’ NPI (LEVEL 1), e.g. Capital Appreciation Return Industrial in the South and Capital Appreciation Return National or r(CIS, CN)
   Correlation with corresponding ‘Region×Type of Return’ NPI (LEVEL 2), e.g. Income Return Office in the Midwest and Income Return Midwest, or r(IOM, IM)
   Correlation with corresponding ‘Property Type×Type of Return’ NPI (LEVEL 2), e.g. Total Return Apartment in the East and Total Return Apartment or r(TAE, TA).
      We select as underlying the level 1 or level 2 indices showing overall the largest correlation with the level 3 indices.
      (ii) Systematic Risk Optimization: We look at total return's risk components in order to investigate how by using different indices as underlying we can increase the scope of systematic risk covered by our contracts. The objective is to select underlying indices that will best capture total risk by turning unique risk into systematic risk. For the three types of return (total return, income return, capital appreciation return), we proceed in three steps:
We first determine Level 3 indices' betas with Level 1 and Level 2 indices.
For each Level 3 index, we then compute unique risk using beta and standard deviation of underlying index: σ_{εi}=[σi²−βi² σ_{(Underlying Index)}²]^{1/2} where σ_{εi} is the Level 3 NPI's unique risk as measured against the underlying index; σi is the Level 3 NPI's standard deviation; βᵢ is the Level 3 NPI's beta as measured against the underlying index; σ_{(Underlying Index)} is the underlying NPI's standard deviation.
Finally, we calculate the ratio of unique risk over total risk (σ_{εi}/σi) and ranked potential underlying indices based on their ability to reduce unique risk, i.e. to best capture total risk. We select as underlying the level 1 or level 2 indices which consistently yield the lowest remaining unique risk after this process called ‘Systematic Risk Optimization’.

Contract Months and Horizon: the choice of contract months and horizon influences the time basis risk that hedgers incur when dealing with the contracts.

Significantly, relevant academic literature notes that:

NCREIF indices' shortcomings tend to lessen as the measurement period increases;
Holding periods for institutional commercial real estate are customarily over 10 years.
   These factors support the case for a long-term contract. As exemplified by index contracts traded on the Chicago Mercantile Exchange (CME) and the Chicago Board of Trade (CBOT), most contracts follow a quarterly cycle starting in March (e.g. S&P 500 futures on the CME), apart from weather derivatives' seasonal contracts. In most futures markets, volume tends to be concentrated with the shortest maturity contracts, hence the usual bias against longer-term contracts. We believe, however, that the only way to use NCREIF indices as underlying is to select an extended contract life, i.e. several quarters. The contracts' maturity has to reflect the nature of the underlying asset (i.e. illiquid cash market) rather than to set up an artificially liquid market at the expense of true reliability and significance. This comment also applies to the rent review cycle. Hence, our contracts are yearly with at least three consecutive years being listed concomitantly. Multi-year contracts are also listed in order to avoid inefficient roll-over of short-term contracts by long-term hedgers. Appendix 2 presents our proposed design for yearly and multi-year contracts for the three types of return mentioned in paragraph [013].

Contract Size: There are two basic ways to determine the size of an index-based futures contract: either as a multiple of the underlying index (e.g. equity index futures on the CME), or using a lump sum as a notional principal (e.g. credit derivatives such as 10 year Interest Rate Swap Futures on the CBOT). We advocate the use of the latter method which alleviates the shortcomings due to the lag in revised index values. Contracts have a fixed value notwithstanding the uncertainty surrounding the true index value. Contract size is an important factor insofar as it impacts transaction costs. Commercial property contracts have to be sufficiently large in order to keep dealing costs reasonable and to make the transacting of commercial-sized hedges feasible. The expected low volatility of the contracts implies that larger contracts (with larger tick sizes) will be more attractive to traders as it will be easier for them to cover trading costs and still profit from one or two tick price movements. A relatively large tick size should also be helpful to traders. Considering the average values of properties in the NCREIF database, we propose a contract size of $1,000,000 per lot. Additionally, given the contracts' expected low volatility, margin requirements are small for total return and capital appreciation return futures, and minimal for income return futures. Coupled with large tick size, low margin requirements encourage speculators to intervene in the market. Finally, there should be no limit on maximum price movement.

Settlement Procedures: Settlement procedures of our property futures have to accommodate two of NCREIF Property Indices' shortcomings which represent a major challenge for finding a reasonably real-time and reliable underlying: index timeliness and index revision. In order to take into account the lack of index timeliness and potential historical revisions in the underlying index value, settlement is completed only after the release of revised NCREIF indices. In the worst case scenario, this would not be before the end of the quarter following the end of the contract. Practically, both the beginning underlying index and the ending underlying index are subject to backward adjustments, thereby affecting the rate of return over the period. Consequently, the beginning date of our contracts should also be postponed so that the contracts' beginning value is based on a revised index. The following time lines for yearly contracts starting in January illustrate this method called the “Method of Deferred Settlement”.

| | INDEX | FUTURES |
|---|---|---|
| Year t | | |
| January | Preliminary NPI (t − 1) | |
| February | | |
| March | Revised NPI (t − 1) is | Futures contracts start |
| | released. | trading based on revised NPI |
| | | (t − 1). |
| . | | |
| . | | |
| . | | |
| Year t + 1 | | |
| January | Preliminary NPI (t) | Futures contracts stop |
| | | trading (last trading day). |
| February | | |
| March | Revised NPI (t) is released. | Settlement based on revised |
| | | NPI (t) (expiry day). |

Thus, last trading day is in January (t+1) and settlement date is in March (t+1) when revised NPI (t) is released. Beginning and Ending Values are respectively revised indices released in March (t) and March (t+1). Ideally, the indices' release date should be as close as possible to the end of the previous quarter and follows consistent standardized procedures. In addition, lags between preliminary and revised indices' release dates should be reduced to a minimum (i.e. in theory, the index should be frozen). In the simulation presented here, we opt for what seems like the longest acceptable lag (approximately two months). In effect, our proposed contracts would only be traded during ten months or so (from March (t) to January (t+1)) although they cover market fluctuations over a twelve-month period (from January 1^{st} (t) to December 31^{st} (t)). Our model can be adapted to any revised index lag and be extended to contracts that would trade similarly to the one presented here but starting with different contract months or covering multi-year periods (as presented in appendix 2).

Property options: Paragraphs [018] to [020] of the specification presents our design for property options.

Options on NCREIF Property Indices: Property options are based on the 75 NCREIF Property indices mentioned in paragraph [013] of this section of the specification. Methodologies as described in paragraph [014] coupled with in-depth market analysis are used to select the most pertinent underlying indices/sub-indices. These options trade on preliminary quarterly indices. Their strike price is expressed in terms of the underlying index price. One property option is for 100 times the underlying index as is customary of equity-index options. They are American or European style. American-style property options offer the flexibility that is missing in the futures market. These options are sensitive to quarterly updates and thus attract a wider range of market participants than the futures contracts which are clearly aimed at hedgers. Long-term property options are listed (with a maturity of up to five years). Contrary to shorter American-style options, long-term options are based on revised annual returns. The more stable nature afforded to these options owing to their long-term expirations targets the more conservative investors.

FLEX options on NPI-based futures contracts: In addition to property futures and options on NCREIF Property Indices, we propose the establishment of FLEX options on the property futures contracts described in paragraphs [009] to [017] of this specification.

(i) Characteristics of FLEX Property Futures options: Flexible options traded on the Chicago mercantile Exchange are known as FLEX. FLEX Property Futures options will use the existing format of FLEX Futures options and apply it to real estate indices. Thanks to their tailor-made features, FLEX Property Futures options enable hedgers to fine-tune their hedging strategies. They are American-style in order to address the uncertainty which surrounds the precise timing of transactions in the commercial real estate market.

(ii) How FLEX Property Futures options work: FLEX Property Futures options are cash-settled. If a call property futures option is exercised, the holder acquires a long position in the underlying property futures contract as described in paragraphs [009] to [017] of the specification. If a put property futures option is exercised, the holder acquires a short position in the underlying property index futures contract as described in paragraphs [009] to [017] of the specification. The effective payoff from a call property futures option is the excess of the futures price at the time of exercise less the strike price; the effective payoff from a put property futures is the strike less the futures price at the time of exercise. Strike price of the FLEX Property Futures options is expressed in terms of index return percentage as described in paragraph [011] of the specification.

The following two pages contain appendices 1 and 2 of the specification.

### APPENDIX 1: INDEX CODES

TABLE 1
TOTAL RETURN INDICES/SUBINDICES

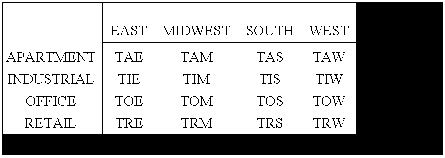

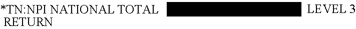

TABLE 2
INCOME RETURN INDICES/SUBINDICES

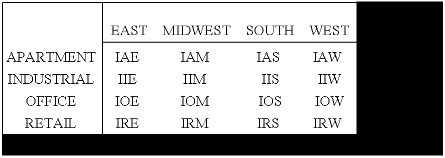

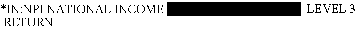

TABLE 3
CAPITAL APPRECIATION RETURN INDICES/SUBINDICES

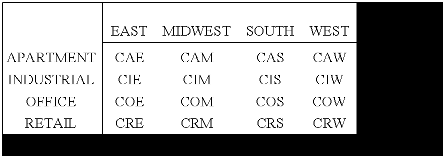

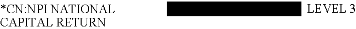

### APPENDIX 2: MAIN FEATURES OF PROPERTY FUTURES CONTRACTS

| | | | CAPITAL |
|---|---|---|---|
| CONTRACT | TOTAL RETURN | INCOME RETURN | APPRECIATION RETURN |
| SPECIFICATIONS | PROPERTY FUTURES | PROPERTY FUTURES | PROPERTY FUTURES |
| NUMBER OF | 5 | 5 | 5 |
| CONTRACTS | | | |
| UNDERLYING | National NPI and 4 | National NPI and 4 | National NPI and 4 |
| INDICES | Property Type NPIs | Property Type NPIs | Property Type NPIs |
| | Index codes: | Index codes: | Index codes: |
| | TN, TA, TI, TO, TR | IN, IA, II, IO, IR | CN, CA, CI, CO, CR |
| CONTRACT | Notional principal: | Notional principal: | Notional principal: |
| SIZE | $1,000,000 per lot | $1,000,000 per lot | $1,000,000 per lot |
| HORIZON | Yearly (with the possibility | Yearly (with the possibility of | Yearly (with the possibility |
| | of multi-year contracts) | multi-year contracts) | of multi-year contracts) |
| CONTRACT | At least 5 consecutive years | At least 5 consecutive years | At least 5 consecutive years |
| MONTHS | listed initially | listed initially | listed initially |
| STARTING | Release date of revised NPI | Release date of revised NPI | Release date of revised NPI |
| TRADING DAY | (t − 1) in March (t) | (t − 1) in March (t) | (t − 1) in March (t) |
| LAST | Release date of preliminary NPI | Release date of preliminary NPI | Release date of preliminary NPI |
| TRADING DAY | (t − 1 + n) in January (t + n) | (t − 1 + n) in January (t + n) | (t − 1 + n) in January (t + n) |
| | where n is the contract's horizon | where n is the contract's horizon | where n is the contract's horizon |
| | (n = 1 for yearly contracts) | (n = 1 for yearly contracts) | (n = 1 for yearly contracts) |
| EXPIRY | Release date of revised NPI | Release date of revised NPI | Release date of revised NPI |
| DAY | (t − 1 + n) in March (t + n) | (t − 1 + n) in March (t + n) | (t − 1 + n) in March (t + n) |
| | where n is the contract's horizon | where n is the contract's horizon | where n is the contract's horizon |
| | (n = 1 for yearly contracts) | (n = 1 for yearly contracts) | (n = 1 for yearly contracts) |
| PERIOD | January (t) to December (t − 1 + n) | January (t) to December (t − 1 + n) | January (t) to December (t − 1 + n) |
| COVERED | where n is the contract's horizon | where n is the contract's horizon | where n is the contract's horizon |
| | (n = 1 for yearly contracts) | (n = 1 for yearly contracts) | (n = 1 for yearly contracts) |
| SETTLEMENT | Contract for difference | Contract for difference based | Contract for difference based |
| PRICE | based on underlying revised | on underlying revised | on underlying revised |
| | NPI's beginning and ending values. | NPI's beginning and ending values. | NPI's beginning and ending values. |
| MAXIMUM | No limits | No limits | No limits |
| PRICE MOVEMENT | | | |
| MARGIN | Small given the expected | Minimal given the expected very | Small given the expected |
| REQUIREMENTS | low volatility | low volatility | low volatility |

What is claimed is:

1- Property futures and property options contracts based on private commercial real estate indices and designed according to a combination of specifications which adapts derivatives' features to the fundamental characteristics of real estate as a slow, illiquid and heterogeneous asset class.

2- The method of ‘deferred settlement’, used in the design of property futures contracts of claim 1 in order to overcome private real estate indices' shortcomings stemming from index revision and a lack of index timeliness, is applicable to any kind of derivatives instruments (e.g., futures, options, OTC swaps) using any non-frozen real estate indices as underlying.

3- The analysis of the NCREIF database within a three level framework as used in the design of the derivative securities of claim 1 sets up an innovative system for coding real estate indices, thereby enabling an easy identification of each index.

4- The two methodologies used for selecting potential underlying indices of the derivative securities of claim 1 (i.e. the ‘method of corresponding correlations analysis’ and the ‘method of systematic risk optimization’) make it possible to determine within the different levels of a real estate index the indices that offer maximum hedging effectiveness.

5- Derivative securities of claim 1 allow the standardization of property derivatives based on private commercial real estate indices and their transacting on organized exchanges.
